(19) United States
(12) Patent Application Publication
(10) Pub. No.: US 2006/0174830 A1
(43) Pub. Date: Aug. 10, 2006

(54) Surface treatment of a tank wall

(75) Inventor: Adrianus Gerardus van Houten, Schalkwijk (NL)

Correspondence Address: HOFFMANN & BARON, LLP, 6900 JERICHO TURNPIKE, SYOSSET, NY, 11791, US

(73) Assignee: Blastrac B.V.

(21) Appl. No.: 11/327,957

(22) Filed: Jan. 9, 2006

(30) Foreign Application Priority Data
Jan. 13, 2005 (NL) NL 1028016

(51) Int. Cl. B05B 13/06

(52) U.S. Cl. 118/306

(57) ABSTRACT

The invention relates to a device for positioning and moving a surface treatment device along a wall. The device comprises a crane which can move along a top edge of the wall substantially in the horizontal direction. The crane comprises a crane jib which projects beyond the edge of the wall and along which a hoisting cable which can move up and down is guided. The surface treatment device is suspended from the hoisting cable in order to be moved up and down along the wall. The device also comprises a frame, preferably in the form of a gantry, which is suspended from the crane jib and can be moved with the crane along the wall substantially in the horizontal direction. The frame is designed to extend over an obstacle, for example a stiffener, extending in the longitudinal direction of the wall and to guide the hoisting cable over the obstacle.

### FIELD OF THE INVENTION

The invention relates to a device for positioning and moving a surface treatment device along a wall.

### BACKGROUND OF THE INVENTION

The chemical industry, for example the petrochemical industry, uses large storage tanks to store, for example, petroleum products or other liquid products. It is desirable for the surface of these tanks to be periodically cleaned, to remove rust and, for example, to be provided with a new layer of paint or treated in some other way. To remove dirt, and/or paint, the wall is, for example, treated with a surface treatment device such as a blasting machine which is held at a short distance from the surface to be treated and blasts an abrasive under pressure onto the surface to be treated.

The invention relates more particularly to a device for positioning and moving a surface treatment device along a wall, which device comprises a crane which can move along a top edge of the wall substantially in the horizontal direction, which crane comprises a crane jib which projects beyond the edge of the tank wall and along which a hoisting cable that can move up and down is guided, the surface treatment device being suspended from the hoisting cable in order to be moved up and down along the wall.

A device of this type is known. The known device is shown in FIG. 1 and is designed to move along a wind girder, which extends horizontally from a tank wall, of a storage tank. The known device has a crane with a crane jib which is designed to allow the hoisting cable to hang down close to the tank wall, so that the surface treatment device is suspended close enough to the surface of the tanker. Since the crane travels along a wind girder, the crane jib is formed from three jib segments which ensure that the hoisting cable is guided around the wind girder towards the tank wall: a first, substantially horizontally extending jib segment, which projects beyond the top edge of the tank; a second jib segment, which extends downwards substantially perpendicularly to the first jib segment; and a third jib segment, which extends obliquely downwards in the direction of the tank wall.

The known device is inherently eminently satisfactory if the tank wall is completely flat. However, it is often the case that stiffeners or other obstacles are arranged in a ring along the periphery of the tank. With the known device, it is then no longer possible for the hoisting cable with the surface treatment device to be positioned sufficiently close to the wall below the stiffener to enable a successful surface treatment to be carried out.

It is an object of the invention to avoid this drawback.

### SUMMARY OF THE INVENTION

According to the invention, this object is achieved by a device for positioning and moving a surface treatment device along a wall, which device comprises a crane which can move along a top edge of the wall substantially in the horizontal direction, which crane comprises a crane jib which projects beyond the edge of the wall and along which a hoisting cable which can move up and down is guided, the surface treatment device being suspended from the hoisting cable in order to be moved up and down along the wall, wherein the device also comprises a frame which is suspended from the crane jib, can be moved with the crane along the wall substantially in the horizontal direction and is designed to extend over an obstacle, for example a stiffener, extending in the longitudinal direction of the wall and to guide the hoisting cable over the obstacle.

According to the invention, in use the frame is positioned over an obstacle. As a result, the hoisting cable can be guided over the obstacle via the frame and beneath the obstacle can again be suspended close to the tank wall. As a result, the surface treatment device can be positioned sufficiently close to the tank wall even beneath the obstacle, allowing a successful surface treatment to be carried out.

It is preferable for the frame to be designed substantially in the form of a gantry.

Further preferred embodiments of the invention are defined in the subclaims.

The invention will be explained in more detail with reference to the drawing.

### BRIEF DESCRIPTION OF THE DRAWINGS

FIG. 1 shows a surface treatment device and a device for positioning and moving it along a tank wall in accordance with the prior art; and

FIG. 2 shows a preferred embodiment of a device for positioning and moving a surface treatment device along a tank wall according to the invention.

### DETAILED DESCRIPTION OF THE PREFERRED EMBODIMENT

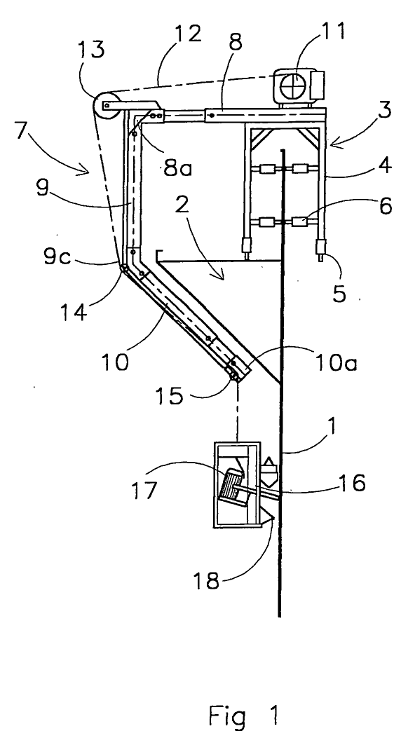

FIG. 1 shows a top part of a tank wall 1 of a cylindrical storage tank. On the top side, the tank wall 1 is provided with a wind girder 2 which extends over the entire periphery of the cylindrical tank.

A crane 3 is positioned at the upper periphery of the tank wall 1. The crane 3 comprises a framework 4 with a set of wheels 5. Some of the set of wheels 5 are supported on the wind girder 2, and in this way the crane 3 can move with respect to the wind girder 2 and the tank wall 1 in the direction perpendicular to the drawing. A number of supporting members 6, which engage on either side of the tank wall 1 and support the structure against the tank wall 1 in order to compensate for moments which are generated by mass forces acting on the crane 3, are also arranged on the framework 4.

A crane jib 7 is arranged on the framework 4. In the exemplary embodiment shown, the crane jib 7 is formed from three jib segments. A first jib segment 8 extends substantially horizontally to beyond the top edge of the tank and in this case beyond the radially outermost edge of the wind girder 2. The first jib segment 8 is telescopic so that its length can be varied. A second jib segment 9 extends substantially vertically downwards with respect to the first jib segment 8, from the projecting end 8a of the first jib segment 8. A third jib segment 10 extends obliquely downwards from the bottom end 9a of the second jib segment 9 in the direction of the tank wall 1. The third jib segment 10 is telescopic so that its length can be varied, with the result that the bottom end 10a of the third jib segment 10 can be positioned close to the tank wall 1.

A winch 11 for winding up and unwinding a hoisting cable 12 is also arranged on the framework 4. The hoisting cable 12 is guided from the winch 11 along the crane jib 7 by means of pulleys 13, 14 and 15 arranged on the crane jib 7. The embodiment of the crane jib 7 shown therefore ensures that the hoisting cable 12 is guided around the wind girder 2 towards the tank wall 1.

A cage 16 in which a blasting machine 17 is positioned is suspended from the hoisting cable 12. The blasting machine 17 has a blasting opening 18 which, in use, is held at a short distance from the surface of the tank wall 1 to be treated and is directed obliquely downwards. The blasting machine 17 blasts an abrasive, such as for example sand or shot, out of the blasting opening 18 under pressure with the aid of air, for example, onto that surface of the tank wall 1 which is to be treated, in order to remove dirt, rust or paint, for example.

The crane 3 and the blasting machine 17 can be operated remotely. By moving the crane 3 over the wind girder 2 along the upper periphery of the tank and moving the cage 16 with the blasting machine 17 vertically up and down on the hoisting cable 12 by means of the winch 11, it is possible to treat the entire surface of the tank wall 1.

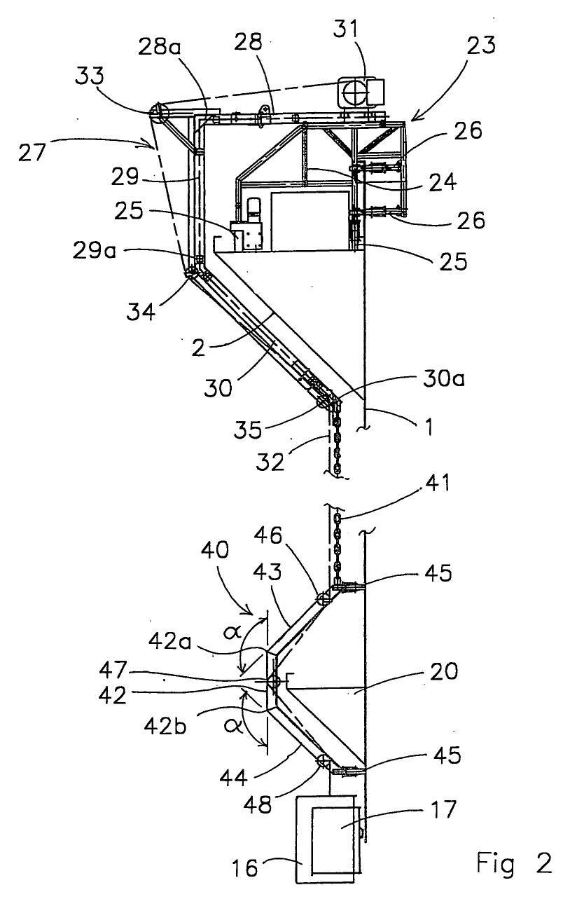

FIG. 2 shows a cross section through a tank wall 1, in which a wind girder 2 is arranged on the top side and a stiffener 20 is arranged further down. If the device according to the prior art shown in FIG. 1 is used, the stiffener 20 is in the way and it is not possible for the cage 16 suspended from the hoisting cable 12 to be positioned close to the tank wall 1 below the stiffener 20. In the area below the stiffener 20, therefore, the tank wall 1 cannot be treated using the known device shown in FIG. 1.

FIG. 2 shows the device according to the invention which creates a solution to the abovementioned problem caused by the stiffener 20.

A crane 23 is positioned at the upper periphery of the tank wall 1. The crane 23 comprises a framework 24 with a set of wheels 25. The wheels 25 are in this case supported on the wind girder 2 and consequently the crane 23 can move with respect to the wind girder 2 and the tank wall 1 in the direction perpendicular to the drawing. A number of supporting members 26, which engage on the tank wall 1 and support the structure against the tank wall 1 in order to compensate for moments caused by mass forces acting on the crane 23, are also arranged on the framework 24.

A crane jib 27 is arranged on the framework 24. In the exemplary embodiment shown, the crane jib 27 is formed from three jib segments. A first, telescopic jib segment 28 extends substantially horizontally to beyond the top edge of the tank and in this case beyond the radially outermost edge of the wind girder 2. A second jib segment 29 extends substantially vertically downwards with respect to the first jib segment 28 from the projecting end 28a of the first jib segment 28. A third jib segment 30, which is telescopic, extends obliquely downwards in the direction of the tank wall 1 from the bottom end 29a of the second jib segment 29. The third jib segment 30 is extended sufficiently far for the bottom end 30a of the third jib segment 30 to be located close to the tank wall 1.

A winch 30 for winding up and unwinding a hoisting cable 32 is also arranged on the framework 24. The hoisting cable 32 is guided along the crane jib 27 from the winch 31 by means of pulleys 33, 34 and 35 arranged on the crane jib 27. The embodiment of the crane jib 27 shown therefore ensures that the hoisting cable 32 is guided around the wind girder 2 towards the tank wall 1.

A frame 40 in gantry form is suspended at the end 30a of the third jib segment 30 by means of a chain 41. The frame 40 in gantry form comprises a centre bar 42, the longitudinal direction of which runs substantially vertically, parallel to the tank wall 1. The frame 40 in gantry form also comprises two legs 43 and 44 which are formed by bars and are connected to the respective ends 42a, 42b of the centre bar 42. In the embodiment shown, the legs 43 and 44 extend at an angle α of approximately 135° with respect to the centre bar 42. In this case, therefore, the legs 43, 44 extend approximately at an angle of 45° with respect to the tank wall 1. At the end of the legs 43, 44 there are wheels 45 as guide members which, in use, are positioned against the tank wall 1. In the example shown, the wheels 45 are approximately perpendicular to the tank wall 1 and have an axis of rotation which, in use, is oriented substantially in the vertical direction. The wheels 45 are therefore designed to guide the frame 40 in gantry form horizontally along the wall 1.

Pulleys 46, 47, 48, which are used to guide the hoisting cable 32 along the frame 40 in gantry form, are arranged on the frame 40 in gantry form. The position of the pulleys 46, 47, 48 with respect to one another is such that the hoisting cable is kept at a distance from the obstacle 20. In the example shown, the top pulley 46 and the bottom pulley 48 are at the same distance from the wall 1 in use. The second pulley 47 is located further away from the wall 1 in use, at a greater distance from the wall 1 than the point of the stiffener 20 which is furthest from the wall 1. The vertical distance from the top and bottom pulleys 46 and 48, respectively, to the middle pulley 47 is such that the hoisting cable is guided far enough around the stiffener 20. Beneath the frame 40 in gantry form, the cage 16 holding the blasting device 17 or another treatment device is suspended from the hoisting cable 32. On account of the gantry construction according to the invention, the area of the wall immediately below the stiffener 20 which is not accessible to the blasting device 17 is minimized.

In use, extension of the first jib segment 28 and/or retraction of the third jib segment 30 of the crane 23 causes the frame 40 in gantry form to be moved sufficiently far from the tank wall 1 for it to be possible for the bottom half of the frame 40 in gantry form to be lowered vertically past the stiffener 20. When the centre of the frame 40 in gantry form is approximately at the height of the stiffener 20, the first jib segment 28 is retracted again and/or the third jib segment 30 is extended again, so that the bottom pulley 45 of the frame 40 in gantry form is supported against the wall 1 below the stiffener 20 and the top pulley 45 is supported above the stiffener 20. This situation is illustrated in FIG. 2. The frame 40 in gantry form forms a type of bridge over the stiffener 20 and guides the hoisting cable 32 past it.

The crane 23 and the blasting machine 17 can be operated remotely. When the crane 23 is being moved along the wind girder 2, the frame 40 in gantry form is moved with it by the chain 41 and will also move along the periphery of the tank wall 1 at the location of the stiffener 20. By means of the winch 31, the cage 16 with the blasting machine 17 can be moved vertically up and down on the hoisting cable 32, and the surface of the tank wall 1 beneath the stiffener 20 can be treated. Therefore, with the device according to the invention, it is possible to treat virtually the entire surface of the tank wall 1 even if a stiffener 20 is present.

It will be clear that for the invention it is not necessary for the frame in gantry form to be designed precisely as shown by way of example in the embodiment presented in FIG. 2. It is also possible to opt for any other suitable form of the frame, provided only that it is suitable for guiding the hoisting cable 32 past the obstacle and further downwards and forms a stable support for the hoisting load. By way of example, it is possible for the legs 43, 44 of the gantry to be positioned at a different angle, for example a right angle, with respect to the centre bar 42, with the result that in use the legs 43, 44 extend at an angle of approximately 90° with respect to the tank wall 1. It is also conceivable to use a frame in gantry form which is composed of just two bars secured directly to one another, for example at an angle of 90° with respect to one another, in which case the length of the legs is such that the hoisting cable 32 remains at a distance from the stiffener 20.

1. Device for positioning and moving a surface treatment device along a wall, which device comprises a crane which can move along a top edge of the wall substantially in the horizontal direction, which crane comprises a crane jib which projects beyond the edge of the wall and along which a hoisting cable which can move up and down is guided, the surface treatment device being suspended from the hoisting cable in order to be moved up and down along the wall, wherein the device also comprises a frame which is suspended from the crane jib, can be moved with the crane along the wall substantially in the horizontal direction and is designed to extend over an obstacle, for example a stiffener, extending in the longitudinal direction of the wall and to guide the hoisting cable over the obstacle.

2. Device according to claim 1, wherein the frame is substantially in the form of a gantry.

3. Device according to claim 2, wherein the frame in the form of a gantry comprises two legs, the free ends of which, in use, are respectively positioned above and below the obstacle, against the tank wall.

4. Device according to claim 3, wherein the legs of the frame in the form of a gantry, in use, extend at an angle of from 45°-90° with respect to the wall.

5. Device according to claim 1, wherein the frame is provided with wheels in order to move along the wall.

6. Device according to claim 5, wherein the frame has the form of a gantry and comprises two legs, the free ends of which, in use, are respectively positioned above and below the obstacle, against the tank wall, in which the legs of the frame in the form of a gantry, in use, extend at an angle of from 45°-90° with respect to the wall, and in which the wheels are arranged at the free end of the legs.

7. Device according to claim 1, wherein guide means are arranged on the frame to guide the hoisting cable along the frame around the obstacle.

8. Device according to claim 7, wherein the guide means comprise pulleys.

9. Device according to claim 1, wherein the crane has wheels to move along the top edge of the wall.

10. Device according to claim 1, wherein the frame is suspended from the crane jib by a chain.

11. Device according to claim 1, wherein the crane jib has a first, substantially horizontally extending jib segment, which projects beyond the top edge of the tank, a second jib segment, which extends downwards substantially perpendicularly to the first jib segment, and a third jib segment, which extends obliquely downwards in the direction of the tank wall.

12. Device according to claim 11, wherein the length of the third jib segment can be varied.

13. Device according to claim 11, wherein the length of the first jib segment can be varied.

14. Frame for use in a device for positioning and moving a surface treatment device along a wall, which device comprises a crane which can move along a top edge of the wall substantially in the horizontal direction, which crane comprises a crane jib which projects beyond the edge of the wall and along which a hoisting cable which can move up and down is guided, the surface treatment device being suspended from the hoisting cable in order to be moved up and down along the wall, wherein the frame is adapted to be suspended from the crane jib, can be moved with the crane along the wall substantially in the horizontal direction and is designed to extend over an obstacle, for example a stiffener, extending in the longitudinal direction of the wall and to guide the hoisting cable over the obstacle.

15. Method for treating the surface of a tank wall wherein a surface treatment device is positioned and moved along a wall by a device, which device comprises a crane which is moved along a top edge of the wall substantially in the horizontal direction, which crane comprises a crane jib which projects beyond the edge of the wall and along which a hoisting cable which can move up and down is guided, the surface treatment device being suspended from the hoisting cable and is moved up and down along the wall, wherein the device also comprises a frame which is suspended from the crane jib, and is moved with the crane along the wall substantially in the horizontal direction and extends over an obstacle, for example a stiffener, extending in the longitudinal direction of the wall and guides the hoisting cable over the obstacle.
